(19) United States
(12) Patent Application Publication
(10) Pub. No.: US 2022/0164488 A1
(43) Pub. Date: May 26, 2022

(54) METHOD FOR RECORDING ELEVATOR DATA AND FOR GENERATING A DIGITAL TWIN OF AN EXISTING ELEVATOR INSTALLATION

(71) Applicant: INVENTIO AG, Hergiswil (CH)

(72) Inventor: Elena CORTONA, Zürich (CH)

(21) Appl. No.: 17/594,047

(22) PCT Filed: May 4, 2020
(86) PCT No.: PCT/EP2020/062301

§ 371 Date: Sep. 30, 2021

(30) Foreign Application Priority Data
May 7, 2019 (EP) 19173039.9

(51) Int. Cl. G06F 30/10; B66B 5/00; B66B 19/00

(52) U.S. Cl. CPC G06F 30/10; G06F 2119/02; B66B 19/00; B66B 5/0087

(57) ABSTRACT

Methods and devices for recording and processing elevator data of an existing elevator system are described. In some instances, each floor is approached by at least one measuring run, and measurement data representing the floor heights are recorded a measuring device. In addition, a three-dimensional digital-double dataset is generated from component model datasets, which reproduces at least each floor recorded by the measuring run in the recorded sequence and with the determined floor height.

### TECHNICAL FIELD

The disclosure relates to recording and processing elevator data of an existing elevator system.

### SUMMARY

Elevator systems are used to transport people within buildings or structures. For this purpose, sufficient operational safety, but ideally also continuous availability, must always be ensured. Therefore, elevator systems are in most cases usually checked and/or serviced at regular intervals. The intervals are generally determined based on experience with similar elevator systems, wherein the intervals must be selected to be sufficiently short in order to ensure operational safety such that a check or maintenance is performed in a timely manner before any safety-endangering operating conditions occur.

In the case of elevator systems, the checks are usually carried out completely independently of the actual current status of the elevator systems. This can mean that a technician must visit the elevator system and inspect it on-site. In such cases, it is often found that no maintenance is urgently required. The visit of the technician thus turns out to be superfluous and causes unnecessary costs. However, in the event that the technician actually detects the need for maintenance, an additional trip is in many cases required because the technician can only determine on-site which components of the elevator system require maintenance, and thus, it only becomes apparent on-site that, for example, spare parts or special tools are needed for maintenance or repair.

In addition, existing elevator systems are not necessarily maintained by the elevator manufacturers themselves. For a variety of reasons, it can happen that so-called external systems, e.g., elevator systems from other elevator manufacturers, are incorporated into the elevator owner's own maintenance portfolio and serviced. If necessary, such external systems are modernized, so that components from different manufacturers are subsequently adapted to one another and installed in a modernized elevator system. In such external systems, for example, the existing third-party elevator control unit is frequently replaced by an in-house elevator control unit, since the architecture and properties of the in-house elevator control unit are known and no special knowledge of the third-party elevator control unit needs to be acquired. However, different parameters or characterizing properties of the existing elevator system, such as the number of floors, the floor heights, the motion profiles of the elevator car via the individual floor heights adjusted to the mechanical and electrical components and the like, must be recorded and implemented in the in-house elevator control unit.

If an external system is added to the maintenance portfolio, there is always the problem of recording the technical data of this existing elevator system and making it available. A technician is usually sent to the external system to be adopted, who then determines and manually records various characterizing properties of this elevator system in a form or in a database. Depending on the complexity of an elevator system to be adopted, 15 to 50 parameters, for example, have to be recorded and manually entered as characterizing properties in the form or in the database. The manual recording of the characterizing properties and their documentation in the database requires an enormous amount of time and can lead to poor data quality depending on the quality of the work of the technician.

Of course, the maintenance responsibility of an existing elevator system can also change several times, wherein experience has shown that the changes made to the elevator system by the different maintenance companies are hardly or not at all documented. Therefore, even if an elevator system is “returning” to the maintenance portfolio, a thorough inventory must first be made with regard to its current characterizing properties.

In WO 2014 027144 A1, the structure of an elevator system is recorded by means of a scanner and compared with a database in which known elevator elements are stored. In this way, the elevator elements that match the recorded structure can be identified in the database. However, the scanning of the structure is associated with considerable effort and there can be a risk in existing elevator systems that, due to deviations in the recorded structure caused by contamination, elevator elements are not identified or incorrect elevator elements are identified.

Therefore, a problem addressed by the present disclosure is that of simplifying the recording of the characterizing properties of an existing elevator system, to increase the data quality of the recorded characterizing properties and to improve their availability and process ability.

This problem can be solved by a method for recording and processing elevator data of an existing elevator system, wherein each floor of the existing elevator system is approached at least once by means of at least one measuring run with the existing elevator system and at least the measurement data representing the floor heights are recorded by means of a measuring device.

In addition, a three-dimensional digital-double dataset is generated from component model datasets and stored in a storage medium, wherein the component model datasets can have different configurations and are defined by characterizing properties that are predefined with default values. For each floor of the elevator system recorded by the measuring run, component model datasets configured as a floor portion component model dataset or component model datasets configured as a shaft portion component model dataset are arranged in the recorded sequence one above the other in the vertical direction. In the case of these component model datasets, the default value of the characterizing property, which defines the height distance to the next floor portion component model dataset, is replaced by the corresponding floor height determined from the measurement data. The feature of being arranged one above the other in the vertical direction means that the component model datasets are arranged such that floors and shaft portions are, analogous to the existing elevator system, also virtually mapped in the three-dimensional digital-double dataset, wherein “vertical” generally describes the direction of transport. In this case, a floor portion component model dataset differs from the shaft portion component model dataset in that it is more open, e.g., it has fewer characterizing properties. A floor portion component model dataset is selected if the floor heights are essentially important for simulations to be carried out later and the recording effort is to be kept to a minimum However, if the shaft portion cross section is also important for the simulations, a shaft portion section component model dataset can be selected, for the dimensions of which characterizing properties are already provided. Logically, it is also possible to first select floor portion component model datasets and subsequently add shaft portion component model datasets thereto.

The measuring device as outlined in the present application can comprise a plurality of devices. For example, this can be a mobile phone with an acceleration sensor, which is placed on the car floor and records the measurement data when traveling from floor to floor. It can also be a transmission unit that can be connected to the elevator control unit of the existing elevator system and reads measurement data from the elevator control unit, prepares them, if necessary, in the intended manner and makes them available to the system described below. In addition to the above-described mobile phone or the transmission unit, the measuring device can also be or comprise a plurality of devices that communicate with one another permanently or temporarily, such as a portable computer, a data logger, a laser scanner, an RFID tag reading device and the like.

In other words, for each floor of the elevator system recorded by the measuring run, a component model dataset configured, for example, as a floor portion component model dataset can be arranged in the recorded sequence one above the other in the vertical direction and the default value of its characterizing property, which defines the height distance to the next floor portion component model dataset, is replaced by the corresponding floor height determined from the measurement data.

By means of the structure of a three-dimensional digital-double dataset, a digital three-dimensional image of the existing elevator system is generated, the essential characterizing properties of which correspond to the characterizing properties of the assigned elevator system due to the transfer and implementation of the measurement data. In this case, at least the number of floors with a corresponding number of floor portion component model datasets and/or shaft portion component model datasets is mapped on the basis of the recorded measurement data and their floor distance or floor height is adapted in accordance with to the measurement data. Such a three-dimensional digital-double dataset thus offers the perfect simulation environment in the sense of the “hardware in the loop” approach in order to program and test, for example, the new elevator control unit before replacing the elevator control unit. The more comprehensively and precisely the existing elevator system is represented in the assigned three-dimensional digital-double dataset, the better the simulation results, of course.

In one embodiment of the disclosure, each floor portion component model dataset or each shaft portion component model dataset can have predefined interfaces, via which component model datasets can be connected to one another and positioned relative to one another. Corresponding characterizing properties of each component model dataset to be added are automatically replicated with the characterizing properties of the component model dataset provided for the connection via the interface. “Replicate” refers to a process that compares the characterizing properties of two interconnected component model datasets to one another if they relate to the same characterizing properties. For example, shaft portion component model datasets are used which replicate the characterizing properties “depth” and “width” that define the shaft portion cross section of the shaft cross section component model datasets connected to each other via the interfaces because an elevator shaft usually has the same shaft cross section over its entire height. Other characterizing properties, such as the material properties of the shaft walls, can also be replicated across all shaft portion component model datasets.

However, the floor heights can be very different and, for example, can be defined as non-replicable if they are not adjacent to one another and therefore not arranged in a corresponding manner. The replication instructions can be stored in a special rule set for each component model dataset. In principle, these replication instructions can stipulate that, in the replication, characterizing properties defined by measured values have priority over characterizing properties defined by default values.

In a further embodiment of the disclosure, each floor portion component model dataset can have predefined interfaces and a component model dataset configured as a shaft portion component model dataset can be connected to these interfaces. The dimensions of the shaft portion component model dataset are also characterized by default values, which logically do not correspond to the dimensions of the assigned elevator system. In the connection, the default value of a characterizing property of the shaft portion component model dataset connected to its interfaces, which defines the height of the shaft portion, is now replaced and thus replicated by the height distance of the floor portion component model dataset connected thereto.

In a further embodiment of the disclosure, each floor portion component model dataset can have predefined interfaces and a component model dataset configured as a shaft component model dataset can be connected to the interfaces of all floor portion component model datasets. In this case, the height distances of all floor portion component model datasets can be added up to a total height, and this total height can replace the default value of the corresponding characterizing property of the shaft component model dataset connected to the interfaces in the sense of a replication of corresponding characterizing properties.

In a further embodiment of the disclosure, a component model dataset configured as an elevator car component model dataset can be arranged in the virtual shaft formed by at least one shaft portion component model dataset. In this case, the individual motion profiles of the elevator car recorded during the measuring run can be assigned in the order of the floors to the elevator car component model dataset as characterizing properties. This can mean that specific component model datasets, which represent movable components of the existing elevator system, can also have dynamic characterizing properties and are therefore, strictly speaking, characterized in four dimensions. Accordingly, such a motion profile stored as a characterizing property has at least one movement direction vector which specifies the movement direction of the assigned component model dataset relative to static component model datasets such as the shaft portion section component model datasets. Furthermore, the motion profile can also have the entire range of motion over the distance to be covered, which is defined as a floor height or a plurality of floor heights. The motion profile represents the acceleration phase, the driving phase at constant speed and the deceleration phase.

In a further embodiment of the disclosure, spatial dimensions of the existing elevator car can be recorded as measured values and the default values of the assigned characterizing properties of the elevator car component model dataset can be replaced by the measured spatial dimensions. Furthermore, the characterizing properties of the at least one elevator car component model dataset can be checked using a collision checking routine and, in the case of colliding dimensions, corresponding characterizing properties of the at least one shaft portion component model dataset can be adapted to the projections of the elevator car component model dataset leading to collisions.

In other words, the shaft cross section of at least the elevator car component model dataset is automatically expanded at least to the floor surface of the elevator car. In this case, the adaptation can be carried out by means of an adaptation routine which provides the usual distances to the car walls for the shaft cross section and, if appropriate, also a cross section add-on for a counterweight component model dataset.

As already mentioned above, the three-dimensional digital-double dataset can be used for dynamic simulations. For example, in a further embodiment of the disclosure, the three-dimensional digital-double dataset can be retrieved from a storage medium and displayed on a screen in a static and/or dynamic manner as a virtual elevator system, reproducing at least the height distances of the floors in the correct ratio to one another.

However, the technician recording the existing elevator system can also enter the elevator system and, for example, measure the shaft pit, the shaft head and the cross section of the shaft and enter the corresponding default values of the component model datasets affected by these measurement data via an input interface of the system described below for recording and processing elevator data of an existing elevator system. In some cases, as part of the measuring device, the technician may also have a laser distance measuring device which can communicate wirelessly with the input interface, so that the measured values are adopted in a partially automated manner. In this case, the technician can be guided, for example, by screen instructions on an output interface of the system, step by step through the measuring run and the recording of further characterizing properties of the existing elevator system.

In a further embodiment of the disclosure, further component model datasets of components of an elevator system can be selected from a database via a graphical user interface (GUI) and inserted into the three-dimensional digital-double dataset via predefined interfaces. The selection can be made in a partially automated manner by the technician, for example, by the system proposing suitable components on the basis of the recorded measurement data processed as characterizing properties. However, the selection can also be made by the technician reading in identifiers of installed components, such as, for example, serial numbers, barcodes, matrix codes, RFID tags and so forth, using a suitable reading device of the system. Due to the recorded identifiers, only components that match these identifiers appear on the graphical user interface. The technician can then insert them at the right place in a three-dimensional virtual representation of the digital-double dataset using, for example, “drag and drop” functions. However, there is also the possibility that images and image sequences recorded using a time-of-flight camera or a laser scanner can be processed by an image data processing program, wherein components installed in the elevator system can be identified by this processing and their corresponding component model datasets can be inserted directly into the three-dimensional digital-double dataset or proposed on the graphical user interface.

For example, counterweight, guide rail, shaft door, car door, drive component model datasets and suspension device component model datasets in different suspension device guiding variants can be selected as component model datasets of components.

In a further embodiment of the disclosure, the characterizing properties defined by measurement data can be provided with a marker, so that they can be distinguished from characterizing properties with default values.

In a further embodiment of the disclosure, a component model dataset of the digital-double dataset can be replaced by a definitive component model dataset in that its characterizing properties provided with a marker are read via a replacement routine, possible defined component model datasets of actually existing components of elevator systems matching the characterizing properties can be determined from a database using said marked characterizing properties, and the replacement component model dataset can optionally additionally be selected by manual inputs. After selection of the appropriate replacement component model dataset, the corresponding component model dataset of the digital-double dataset is deleted and the replacement component model dataset is inserted at the corresponding interfaces of the digital-double dataset that the deleted component model dataset has released.

As has already been mentioned several times above, according to the disclosure, a system for recording and processing elevator data of an existing elevator system is provided, with which the previously described methods can be carried out. The system comprises at least one measuring device, by means of which, via at least one measuring run with an existing elevator system, at least those measurement data can be recorded, from which floor heights of the floors of the elevator system can be determined. This includes, for example, the motion profile and the travel time between the floors, from which the floor heights can be calculated. Of course, the floor heights can also be determined from data of the elevator control unit of the existing elevator system, for example, from a shaft information system connected to the elevator control unit, from sensor signals generated by sensors of the existing elevator system that are connected to the elevator control unit, and so forth. The measuring device can be a device specifically configured for this purpose and equipped with data storage resources such as RAM, ROM, EPROM, hard disk memory, SDRAM and the like, data processing resources such as processors, processor networks, and the like, interfaces such as an input interface and an output interface, and device interfaces which allow for communication with other devices such as the elevator control unit of the existing elevator system, the programmable device of the system described below, and the like, as well as sensors. However, the measuring device can also be a conglomerate of different, physically separate devices which have the properties and resources described above as a whole and can exchange data with one another.

The system furthermore includes a programmable device and a computer program product with machine-readable program instructions. In this case, the programmable device can be a single device such as a personal computer, a laptop, a mobile phone, a tablet, an elevator control unit of an elevator system, or the like. However, the programmable device may also comprise one or more computers. In particular, the programmable device can be formed from a computer network which processes data via cloud computing. For this purpose, the programmable device can have a memory in which the data of the three-dimensional digital-double dataset and the component model datasets of various configurations required for its generation can be stored, for example, in electronic or magnetic form. The programmable device may also have data processing options. For example, the programmable device may have a processor, by means of which data from all of these datasets and the machine-readable program instructions of the computer program product can be processed. The programmable device may also have data interfaces via which data can be input into the programmable device and/or output from the programmable device. The programmable device may also be implemented in a spatially distributed manner, for example, when data are processed in a data cloud distributed over a plurality of computers.

In particular, the programmable device can be programmable, e.g., it can be prompted by a suitably programmed computer program product to execute or control computer-processable steps and data of the method according to the disclosure. The computer program product may contain instructions or code which, for example, prompt the processor of the device to generate, store, read, process, modify, etc. the data of the three-dimensional digital-double dataset. The computer program product may be written in any computer language.

By executing the computer program product on the programmable device, a three-dimensional digital-double dataset can be generated from component model datasets and stored in a storage medium of the programmable device while taking into account the measurement data recorded by the measuring device. The component model datasets that can be retrieved for this purpose from a database, which is preferably also stored in the data cloud, have different configurations and are defined by characterizing properties that are predefined with default values.

When generating the three-dimensional digital-double dataset, one component model dataset each configured as a floor portion component model dataset or a shaft portion component model dataset, in particular for each floor of the elevator system recorded by the measuring run, is arranged in the recorded sequence one above the other in the vertical direction in the three-dimensional digital-double dataset generated by the programmable device. In order to correctly reproduce the existing elevator system in digital form, the default value of its characterizing property, which defines the height distance to the next floor portion component model dataset, is replaced by the corresponding floor height determined from the measurement data.

In order to facilitate the recording of the relevant parameters, the measuring device may also be connected to the elevator control unit of the existing elevator system. As a result, the measuring device is able to extract characterizing properties from the elevator control unit and to transmit them to the programmable device of the system.

In summary, it can be said that the computer program product comprises machine-readable program instructions which, when executed on a programmable device, prompt the device to carry out or control the above-described embodiments of the method according to the disclosure.

The computer program product may be stored on any computer readable medium, for example, a flash memory, a CD, a DVD, RAM, ROM, PROM, EPROM, a floppy disk, and the like. The computer program product and/or the data to be processed with it may also be stored on a server or a plurality of servers, for example, in a data cloud, from where they can be downloaded via a network, for example, the Internet.

It should be noted that some of the possible features and advantages of the disclosure are described herein with reference to different embodiments. A person skilled in the art recognizes that the features can be combined, transferred, adapted, or exchanged in a suitable manner in order to arrive at further embodiments of the disclosure.

### BRIEF DESCRIPTION OF THE DRAWINGS

Embodiments of the disclosure will be described in the following with reference to the accompanying drawings, with neither the drawings nor the description being intended to be interpreted as limiting to the disclosure.

FIG. 1 schematically shows, as a three-dimensional view, an existing elevator system, wherein its elevator shaft is shown schematically for the sake of clarity and the floors to be connected by the elevator system are indicated by a broken line;

FIGS. 2A to 2D schematically show example method steps according to the disclosure for generating a three-dimensional digital-double dataset of the existing elevator system shown in FIG. 1; and

FIG. 3 schematically shows, as a three-dimensional view, certain components of a system that is suitable for carrying out the method shown in FIGS. 2A to 2D.

### DETAILED DESCRIPTION

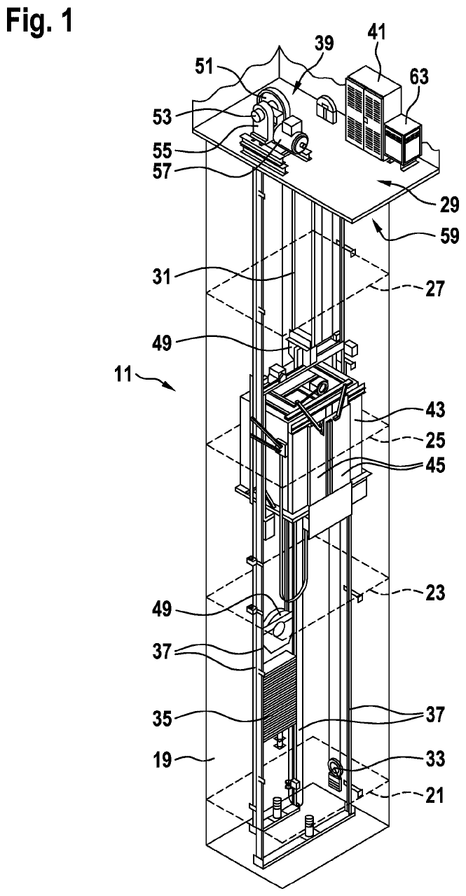

FIG. 1 schematically shows as a three-dimensional view an existing elevator system 11, wherein its elevator shaft 19 is shown only schematically for the sake of clarity and the floors 21, 23, 25, 27 constructed on-site and to be connected by the elevator system 11 are only indicated by a broken line.

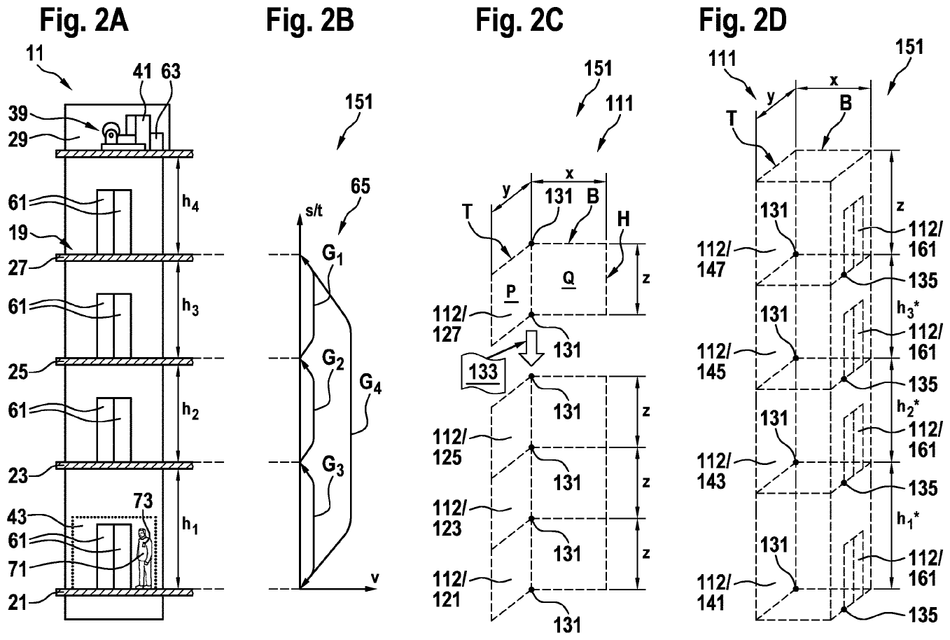

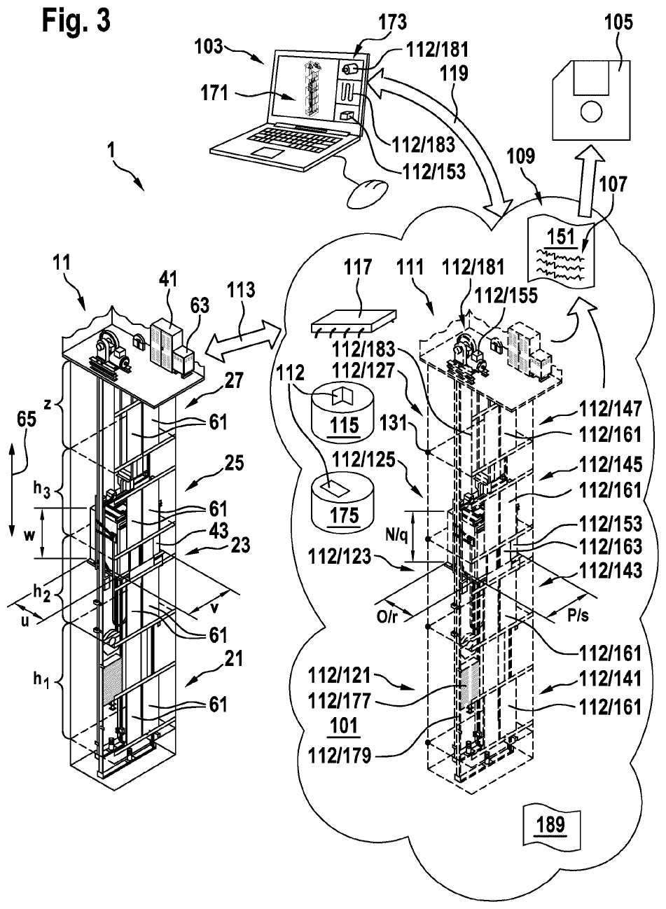

The elevator system 11 comprises many different components which are usually arranged in the elevator shaft 19 constructed on-site. These also include all the components listed in this paragraph, such as guide rails 37 mounted on the walls of the elevator shaft 19, an elevator car 43 guided on the guide rails 37, and a counterweight 35 guided on the guide rails 37. The counterweight 35 is connected to the elevator car 43 in a load-bearing manner by a suspension device 31, for example, a steel cable or a belt. In the present embodiment, the suspension device 31 is guided in a so-called 2:1 suspension device arrangement over deflection rollers 49 and a traction sheave 51. Of course, other suspension device guiding variants such as 1:1, 3:1 and the like are also possible. The traction sheave 51 is driven by a drive unit 39 which usually comprises a service brake 53, a reduction gear 55, and a drive motor 57. The drive motor 57 is driven by an elevator control unit 41. In the present embodiment, the drive unit 39 and the elevator control unit 41 are arranged in a machine room 29 which is located exactly above the shaft head 59 of the elevator shaft 19. The elevator car 43 has car doors 45 which can be temporarily coupled to shaft doors 61 (see FIGS. 2A and 3) arranged on the floors 21, 23, 25, 27. There are also safety devices 33 that monitor the correct functioning of the existing elevator system.

Using FIGS. 2A to 2D, possible method steps of the method 151 according to the disclosure for recording and processing elevator data of an existing elevator system 11 and an associated generation of a three-dimensional digital-double dataset 111 of the existing elevator system 11 shown in FIG. 1 will be described below. FIG. 2A again shows the existing elevator system 11 in a simplified manner, wherein only the outer contours of the elevator shaft 19, the floor slabs of floors 21, 23, 25, 27, the elevator car 43, the shaft doors 61 and the machine room 29 are shown.

According to a possible embodiment of the disclosure, as shown in FIG. 2B, at least one measuring run 65 with the elevator car 43 of the existing elevator system 11 is used to approach each floor 21, 23, 25, 27 of the elevator system 11 at least once, and at least the measurement data G1, G2, G3, G4, h1, h2, h3 which represent floor heights h1, h2, h3 are recorded by means of a measuring device 63. In the present embodiment, the measuring device 63 is a data recording device which receives the measurement data G1, G2, G3, G4, h1, h2, h3 from the elevator control unit 41 or extracts and stores them from control signals and sensor data transmitted to the elevator control unit 41 from sensors installed in the elevator system 11, or which can forward these measurement data G1, G2, G3, G4, h1, h2, h3. For this purpose, the measuring device 63 can have a suitable computer program which acts on the elevator control unit 41 of the existing elevator system 11 and initiates the required measuring run 65. In this case, for example, the floor heights h1, h2, h3 can be read out directly from the control signals of the elevator control unit 41 as measurement data h1, h2, h3 which are transmitted, for example, from a shaft information system (not shown) of the existing elevator system 11 to the elevator control unit 41. Furthermore, the motion profiles can be recorded as measurement data G1, G2, G3, G4. Since these represent the speed V of the elevator car 43 over time t, the floor heights h1, h2, h3 can of course also be calculated from these measurement data G1, G2, G3, G4.

Of course, the measuring run 65 may also be carried out without measurement data G1, G2, G3, G4, h1, h2, h3 being read out from the elevator control unit 41 of the existing elevator system 11. For this purpose, for example, a technician 71 can enter the elevator car 43 with a mobile phone (smartphone) and carry out the measuring run 65 with the existing elevator system 11. The mobile phone as the measuring device 73 records the acceleration and deceleration profile and the travel time from floor to floor or the motion profiles as measurement data G1, G2, G3, G4. The technician preferably places the mobile phone or the measuring device 73 on the floor of the elevator car 43 during the measuring run 65 in order not to falsify the measurement data G1, G2, G3, G4. The floor heights h1, h2, h3 of the individual floors 21, 23, 25, 27 can in turn be calculated from these measurement data G1, G2, G3, G4.

As shown in FIG. 2C, by taking into account these measurement data G1, G2, G3, G4, h1, h2, h3, a three-dimensional digital-double dataset 111 can be generated step by step from component model datasets 112 and stored in a storage medium 101 (see FIG. 3). The component model datasets 112 can have different configurations and are defined by characterizing properties B, T, H that are predefined with default values x, y, z.

The characterizing properties B, T, H that define the nature of the component model datasets 112 can be, for example, geometric dimensions of the components they represent, weights of the components they represent, material properties of the components they represent, and/or surface properties of the components they represent. Of course, dynamic information, such as the motion profiles already mentioned, can also be assigned to a component model dataset 112 as characterizing properties and characterize its dynamic behavior. In other words, a plurality of characterizing properties B, T, H of one component or of a plurality of components of the elevator system 11 can be determined and stored as measurement data G2, G3, G4, h1, h2, h3 in the three-dimensional digital-double dataset 111. Geometric dimensions of the components can be, for example, a length, a width, a height, a depth, a cross section, radii, fillets, etc. of the components. Material properties of the components can be, for example, a type of material used to form a component or a partial region of a component. Furthermore, material properties can also be strength properties, hardness properties, electrical properties, magnetic properties, optical properties, etc. of the components. Surface conditions of the components can be, for example, roughness, textures, coatings, colors, reflectivities, etc. of the components. The characterizing properties B, T, H can refer to individual components or component groups. For example, the characterizing properties B, T, H can relate to individual components from which larger, more complex component groups are composed. Alternatively or additionally, the characterizing properties B, T, H may also refer to more complex equipment composed of a plurality of components, such as drive motors, gear units, suspension device, etc.

In order to generate the three-dimensional digital-double dataset 111, in each case a component model dataset 112 configured as a floor portion component model dataset 121, 123, 125, 127 can be arranged in the recorded sequence one above the other in the vertical direction for each floor 21, 23, 25, 27 of the elevator system 11 recorded by the measuring run 65, wherein interface information 131, which is correctly positioned relative to one another and consolidated, is preferably defined for this purpose on the floor portion component model dataset 121, 123, 125, 127, for example, by means of a rule set 133. As already mentioned, component model datasets 112 are defined by characterizing properties B, T, H, and these characterizing properties B, T, H are in turn predefined by default values x, y, z. In the present embodiment of FIG. 2C, the floor portion component model datasets 121, 123, 125, 127 are defined by two surfaces P and Q arranged at right angles to one another, wherein their planar dimensions are each predefined by the characterizing properties width B, depth T, and height H with a corresponding default value x, y, z. Accordingly, this three-dimensional digital-double dataset 111 or the virtual model thus generated, which can be represented in three dimensions, initially only correctly displays the number of floors 21, 23, 25, 27 of the elevator system 11.

As FIG. 2D shows, the three-dimensional digital-double dataset 111 or this virtual model which can be represented three-dimensionally is now gradually refined and specified in that the default value z of the characterizing property height H of each floor portion component model dataset 121, 123, 125, 127, which defines the height distance to the next floor portion component model dataset, is replaced by the corresponding floor heights h1, h2, h3 determined from the measurement data G1, G2, G3, G4, h1, h2, h3. On the basis of the floor heights h1, h2, h3 shown in FIG. 2D, it is evident that they differ significantly from the default values x, y, z of FIG. 2C and also from one another. It can also be seen that the floor height h4 of the top floor 27 cannot be calculated or defined by the measurement data G1, G2, G3, G4, h1, h2, h3 determined by means of a measuring run 65. For example, the technician must measure said floor height h4 manually and record it as measurement data h4 or its default value z is initially maintained until further measurement data on this characterizing property height H of the top floor 27 are available. Those characterizing properties B, T, H whose default values x, y, z have been replaced by measurement data G1, G2, G3, G4, h1, h2, h3 can be provided with a marker, as shown symbolically in the present embodiment with an asterisk as h1*, h2*, h3*. Such a marker can be a code portion, a prefix, a suffix, and the like.

As previously described, each floor portion component model dataset 121, 123, 125, 127 has predefined interfaces 131. These serve not only as reciprocal positioning points when the floor portion component model datasets 121, 123, 125, 127 are combined, but also as interfaces 131 when additional component model datasets 112 are added. As shown in FIG. 2D, a component model dataset 112 configured as a shaft portion component model dataset 141, 143, 145, 147 can now also be added to these interfaces 131. For this purpose, the default value x, y, z of a characterizing property B, T, H of the shaft portion component model dataset 141, 143, 145, 147 connected to its interfaces 131, which defines the shaft portion height, is replaced or replicated by the corresponding floor height h1, h2, h3 of the floor portion component model dataset 121, 123, 125, 127.

Of course, there is also the possibility of directly using a shaft component model dataset or a plurality of shaft component model datasets 141, 143, 145, 147 as a component model dataset 112 instead of the floor portion component model datasets 121, 123, 125, 127 described above. These preferably also have the characterizing properties B, T, H in the sense of the floor portion component model datasets 121, 123, 125, 127 and the interfaces 131 in order to be able to correctly generate the three-dimensional digital-double dataset 111 and to correctly reflect at least the number of floors and the floor heights h1, h2, h3, z.

In principle, each component model dataset 112, depending on its configuration, can have a plurality of interfaces 131, 135 for adding further component model datasets 112. For example, the shaft portion component model datasets 141, 143, 145, 147 can have, in addition to the interfaces 131 matching the floor portion component model datasets 141, 143, 145, 147 and/or each other, also interfaces 135 for shaft door component model datasets 161.

FIG. 3 schematically shows as a three-dimensional view the essential components of a system 1 which is suitable for carrying out the method 151 shown in FIGS. 2A to 2D. This system 1 for recording and processing elevator data of an existing elevator system 11 essentially has the following system parts:
at least one measuring device 63, by means of which at least one measuring run 65 with the existing elevator system 11 can be used to record at least the measurement data h1, h2, h3 from which floor heights h1, h2, h3 of the floors 21, 23, 25, 27 of the elevator system 11 can be determined;
a programmable device 101; and
a computer program product 109 with machine-readable program instructions 107.

As already mentioned in the description of FIG. 2, the measuring device 63 of the depicted embodiment accesses measurement data G1, G2, G3, G4, h1, h2, h3 of the elevator control unit 41 of the existing elevator system 11 and transmits it, symbolically represented by the double arrow 113, to the programmable device 101.

The programmable device 101 can be a single device such as, for example, a personal computer, a laptop, a mobile phone, a tablet, the elevator control unit 41 of the existing elevator system 11, or the like. However, the programmable device 101 can also comprise one or more computers. In particular, the programmable device 101, as shown in FIG. 3, can be formed from a computer network which processes data in the form of a data cloud. For this purpose, the programmable device 101 can have a storage medium 115 in which the data of the digital-double dataset 111 and the component model datasets 112 of various configurations required for its generation can be stored, for example, in electronic or magnetic form. The programmable device 101 can also have data processing options. For example, the programmable device 101 can have a processor 117, by means of which data from all these component model datasets 112 and the machine-readable program instructions 107 of the computer program product 109 can be processed. The programmable device 101 can also have the device interfaces symbolically represented by the double arrow 119, via which data can be input into the programmable device 101 and/or output from the programmable device 101. The programmable device 101 can also be implemented in a spatially distributed manner, for example, when data is processed in a data cloud distributed over a plurality of computers.

In particular, the programmable device 101 can be programmable, e.g., it can be prompted by a suitably programmed computer program product 109 to execute or control computer-processable steps and data of the method 151 according to the disclosure. The computer program product 109 can contain instructions or code which, for example, prompt the processor 117 of the programmable device 101 to generate, store, read, process, modify, etc. the data of the three-dimensional digital-double dataset 111. The computer program product 109 can be written in any computer language.

The machine-readable program instructions 107 of the computer program product 109 reproduce the method steps of the method 151 according to the disclosure, shown by way of example in FIGS. 2A to 2D, in a machine-processable manner. Furthermore, the machine-readable program instructions 107 can have a plurality of other program routines, such as different conversion routines for determining a floor height h1, h2, h3 from a motion profile G1, G2, G3, G4 (see FIG. 2B), control routines for controlling the interactions between the elevator control unit 41 and the measuring device 63, assignment routines which check the arrangement of component model datasets 112 for their compatibility, positioning routines which assume the exact positioning of the component model datasets 112 via the interfaces, rule sets 133 (see FIG. 2C), collision check routines which check static and dynamic characterizing properties of the component model datasets 112 arranged in the three-dimensional space with respect to one another, transmission protocols, control routines for the device interfaces, instruction routines for the technician, and the like.

By executing the computer program product 109 on the programmable device 101, taking into account the measurement data recorded by the measuring device 63, a three-dimensional digital-double dataset 111 can be generated from component model datasets 112 and stored in the storage medium 115 of the programmable device 101. Here, the component model datasets 112 can have different configurations and be configured, for example, as a floor portion component model dataset 121, 123, 125, 127, shaft portion component model dataset 141, 143, 145, 147, elevator car component model dataset 153, car door component model dataset 163, shaft door component model dataset 161, drive component model dataset 155 and so forth, and can be defined by characterizing properties N, O, P that are predefined with default values q, r, s.

For each floor 21, 23, 25, 27 of the elevator system 11 recorded by the measuring run 65, a respective component model dataset 112 configured as a floor portion component model record 121, 123, 125, 127 is arranged one above the other in the vertical direction in the recorded sequence in the three-dimensional digital-double dataset 111 generated by the programmable device 101. As shown in FIGS. 2A to 2D, the default value z of its characterizing property H, which defines the height distance to the next floor portion component model dataset, is replaced by the corresponding floor height h1, h2, h3 determined from the measurement data G1, G2, G3, G4, h1, h2, h3.

Furthermore, a component model dataset configured as an elevator car component model dataset 153 can be arranged in the virtual shaft formed by at least one shaft component model dataset 141, 143, 145, 147. In this case, the individual motion profiles G1, G2, G3, G4 of the elevator car 43 recorded during the measuring run 65 can also be assigned as characterizing properties to the elevator car component model dataset 153 in the hierarchy of the floors 21, 23, 25, 27. This can mean that dynamic properties relative to the shaft component model datasets 141, 143, 145, 147 are assigned to the elevator car component model dataset 153, so that the three-dimensional digital-double dataset 111 with partially dynamic or movable component model datasets 112 can be displayed on a screen 171, for example. In other words, the three-dimensional digital-double dataset 111 can be retrieved from the storage medium 115 and, as a virtual elevator system reproducing at least the floor distances between the floors in the correct ratio to one another, displayed statically and/or dynamically on a screen 171. Due to the dynamic properties, the virtual elevator car displayed on the screen 171 by the elevator car component model dataset 153 can also execute the same movements with the same movement directions, the same accelerations, speeds and decelerations as the elevator car 43 of the existing elevator system 11 within the virtual elevator shaft formed by the shaft component model datasets 141, 143, 145, 147.

Furthermore, spatial dimensions of the elevator car 43 measured by the technician or extracted from plans and CAD files can be recorded as measured values u, v, w, and the default values q, r, s of the assigned characterizing properties N, O, P of the elevator car component model dataset 153 can be replaced by the measured spatial dimensions, wherein the default values x, y, z of the characterizing properties T, B, H of the shaft portion component model datasets 141, 143, 145, 147 or of the shaft component model dataset is checked by means of a collision routine and, in the case of colliding dimensions, corresponding characterizing properties T, B, H are adapted to the projections of the characterizing properties N, O, P of the elevator car component model dataset 153 which lead to collisions. In particular, the cross section of the shaft portion component model datasets 141, 143, 145, 147, which is still defined by default values x, y, can be too small for the actual dimensions of the elevator car 43. If necessary, a required play between the car walls and the shaft walls can be added to the car dimensions as standard in order to determine the characterizing properties T, B of the shaft portion component model datasets 141, 143, 145, 147 that characterize the shaft cross section, starting from the elevator car 43.

In order to further simplify the generation of the three-dimensional digital-double dataset 111, further component model datasets 112 of components of an elevator system can be selected from a database 175 via a graphical user interface 173 of an input interface/output interface 103 such as the illustrated laptop and inserted into the three-dimensional digital-double dataset 111 via predefined interfaces 131, 135. Components of existing elevator systems 11 depicted in the database 175 as component model datasets 112—such as various counterweight component model datasets 177, guide rail component model datasets 179, shaft door component model datasets 161, car door component model datasets 163, drive component model datasets 181 and suspension device component model datasets 183 in various suspension device guiding options—can be available for selection.

The component model datasets of actually existing components, which can be retrieved from the database 175, can have completely defined characterizing properties N, O, P based on measurement results. In order to further improve the digital-double dataset 111, its component model datasets 112, which have mixed characterizing properties N, O, P defined with measurement data u, v, w and default values q, r, s, can be replaced by a defined component model dataset 181, 183, 153 from the database 175 with defined characterizing properties N, O, P. This can be done automatically in that the characterizing properties N, O, P provided with a marker * are read out by a replacement routine 189 and, on the basis of these marked characterizing properties, possible defined component model datasets 181, 183, 153 of actually existing components of elevator systems 11 that match the characterizing properties N, O, P are determined from the database 175. Subsequently, the replacement component model dataset 112 can, where appropriate, be additionally selected from these proposed defined component model datasets 181, 183, 153 by manual inputs. After selection, the replacement routine 189 can automatically delete the component model dataset 112 to be replaced and insert the replacement component model dataset 112. In some cases, there are also identifiers on components of the existing elevator system 11, such as barcodes, matrix codes, RFID tags and the like, which allow a clear selection and use of the component model dataset 112 representing this component by suitable detection in the system 1.

The computer program product 109 may be or may have been stored on any computer-readable medium 105.

Although the present disclosure has been described in FIGS. 1 to 3 using the example of a simple existing elevator system 11 and using a simple digital-double dataset 111 which depicts it and is generated only rudimentarily with few component model datasets 112, it is obvious that the described method 151 and the corresponding system 1 can similarly also be applied to elevator systems 11 of a more complex design. Even if only one elevator car 43 is described and shown in the figures, the system 1 according to the disclosure and the method 151 according to the disclosure can naturally also be used in existing elevator systems 11 with a plurality of elevator cars 43.

Finally, it should be noted that terms such as “comprising,” “having,” etc. do not preclude other elements or steps and terms such as “a” or “an” do not preclude a plurality.

Furthermore, it should be noted that features or steps that have been described with reference to one of the above embodiments may also be used in combination with other features or steps of other embodiments described above.

1-13. (canceled)

14. A method for recording and processing elevator data of an existing elevator system, the method comprising:
generating a three-dimensional digital-double dataset from component model datasets and stored in a storage medium, wherein the component model datasets can have different configurations and are defined by characterizing properties that are predefined with default values,
approaching each floor of the existing elevator system at least once by at least one measuring run with the existing elevator system,
recording at least measurement data representing floor heights by a measuring device,
wherein, for each floor of the elevator system recorded by the measuring run, component model datasets configured as a floor portion component model dataset or component model datasets configured as a shaft portion component model dataset are arranged in recorded sequence one above the other in a vertical direction, and in which the default value of the characterizing property, which defines a height distance to the next floor portion component model dataset or shaft portion component model dataset, is replaced by the corresponding floor height determined from the measurement data.

15. The method of claim 14, wherein each floor portion component model dataset or each shaft portion component model dataset has predefined interfaces, via which component model datasets can be connected to one another and positioned relative to one another, wherein corresponding characterizing properties of each component model dataset to be added are automatically replicated with the corresponding characterizing properties of the component model dataset provided for the connection via the interface.

16. The method of claim 14, wherein a component model dataset configured as an elevator car component model dataset is arranged in a virtual shaft formed by at least one shaft portion component model dataset and motion profiles of the existing elevator car recorded during the measuring run are assigned as characterizing properties to the elevator car component model dataset in a hierarchy of the floor.

17. The method of claim 16, wherein spatial dimensions of an existing elevator car are recorded as measured values and the default values of the assigned characterizing properties of the elevator car component model dataset can be replaced by the measured spatial dimensions, wherein the default values of the characterizing properties of the shaft portion component model datasets are checked using a collision checking routine and, in the case of colliding dimensions, corresponding characterizing properties are adapted to the projections leading to collisions.

18. The method of claim 14, wherein the three-dimensional digital-double dataset can be retrieved from a storage medium and displayed on a screen in a static and/or dynamic manner as a virtual elevator system, reproducing at least the height distances of the floors in the correct ratio to one another.

19. The method of claim 14, wherein further component model datasets of components of an elevator system can be selected from a database via a graphical user interface and inserted into the three-dimensional digital-double dataset via predefined interfaces.

20. The method of claim 19, wherein at least counterweight, guide rail, shaft door, car door, drive component model datasets and suspension device component model datasets in different suspension means guiding variants can be selected as component model datasets of components.

21. The method of claim 14, wherein the characterizing properties defined by measurement data are provided with a marker, so that they can be distinguished from characterizing properties with default values.

22. The method of claim 21, wherein a component model dataset of the digital-double dataset can be replaced by a definitive component model dataset in that its characterizing properties provided with a marker are read via a replacement routine, possible defined component model datasets of actually existing components of elevator systems matching the characterizing properties are determined from a database using said marked characterizing properties, and the replacement component model dataset can optionally additionally be selected by manual inputs.

23. An elevator system comprising a system for recording and processing elevator data of the elevator system, wherein the system comprises:
at least one measuring device, wherein by at least one measuring run with the elevator system at least those measurement data can be recorded by the measuring device, from which the floor heights of the floors of the elevator system can be determined;
a programmable device; and
a computer program product with machine-readable program instructions, wherein:
during the measuring run with the elevator system each floor of the elevator system is approached at least once and by means of a measuring device at least those measurement data is recorded, which represent floor heights,
by executing the computer program product on the programmable device and by taking into account the measurement data recorded by the measuring device during the measurement run, a three-dimensional digital double data set can be built up from component model data sets and can be stored in a storage medium of the programmable device,
the component model data sets being able to have different configurations and are defined by characterizing properties which are predefined with default values,
in the three-dimensional digital double data set created by the programmable device, for each floor of the existing elevator installation recorded by the measurement run in the recorded order, a component model data set, configurable as a floor section component model data set or shaft section component model data set is arranged one above the other in the vertical direction and the default value of its characteristic property, which represents the distance height to the next floor section component model data set or shaft section component model data is replaced by the corresponding floor height determined from the measurement data, and wherein the measuring device is connected to the elevator control unit of the existing elevator system and characterizing properties can be extracted by the measuring device from control signals of the elevator control unit and transmitted to the programmable device.
